(19) United States
(12) Patent Application Publication
(10) Pub. No.: US 2009/0124501 A1
(43) Pub. Date: May 14, 2009

(54) Silicic Acid Componenet Supplying Agent For Algae And Method For Supplying Silicic Acid Component To Algae

(75) Inventors: Masanori Okauchi, Mie (JP); Koji Nakamura, Aichi (JP)

Correspondence Address: KINNEY & LANGE, P.A., THE KINNEY & LANGE BUILDING, 312 SOUTH THIRD STREET, MINNEAPOLIS, MN, 55415-1002, US

(73) Assignees: Incorporated Administrative Agency Fisheries Research Agency, Kanagawa (JP); Fuji Silysia Chemical Ltd, Aichi (JP)

(21) Appl. No.: 12/225,024

(22) PCT Filed: May 30, 2007
(86) PCT No.: PCT/JP2007/061018

§ 371 Date: Sep. 11, 2008

(30) Foreign Application Priority Data
May 31, 2006 (JP) 2006-152308

(51) Int. Cl. A01N 59/00

(52) U.S. Cl. 504/151

(57) ABSTRACT

A silicic acid component supplying agent for algae to be added to water in which algae requiring silicic acid to grow live, in order to supply a silicic acid component to the algae. The agent includes a silicic acid gel, as a main component, obtained by previously causing a reaction between an alkali metal silicate and a mineral acid within a system other than the water in which the algae live.

### TECHNICAL FIELD

The present invention relates to a silicic acid component supplying agent for algae which is used for culturing algae to be used as foods for farming fish and shellfish and to a method of supplying a silicic acid component to algae.

### BACKGROUND ART

Diatoms (epilithic diatoms and floating diatoms) and the like are used as foods for farming shellfish, crustaceans, echinoderms, etc., and also used as foods for zooplankton in the case of farming fish and shellfish which feed on zooplankton. It is, therefore, important to establish a technology to allow stable culture of diatoms and the like, in order to supply a sufficient amount of diatoms and the like to be used for farming fish and shellfish of these types.

Particularly, in the case of culturing diatoms, it is indispensable to supply a silicic acid component to a culture solution. Conventionally, a method of adding an appropriate amount of water glass or sodium metasilicate has been employed for this purpose (see, for example, below indicated Patent Document 1 (particularly, paragraph [0061] and others)).

### Patent Document 1: Unexamined Japanese Patent Publication No. 2004-187675

### DISCLOSURE OF THE INVENTION

### Problems to be Solved by the Invention

There is a problem as described below. An alkali metal silicate, such as water glass or sodium metasilicate, is poorly-soluble in water and reacts with an inorganic component (for example, calcium) in water even after being dissolved thereby to be precipitated. Accordingly, an excessive addition of an alkali metal silicate is prone to lead to formation of clouding or a sludge mass.

Especially in the case of culturing diatoms in a large culture tank, a precipitate is deposited on or attached to a drainage system or an aeration system provided in the culture tank. Without sufficient maintenance, functions of these systems may be deteriorated or break down. This may lead to, in the natural world, formation of sludge at a lake bottom or a sea bottom. There is also a problem that a silicic acid component once deposited as a precipitate is not used by phytoplantkon, which leads to a loss of the silicate acid component and to a great waste.

To simply suppress formation of a precipitate, a technique of reducing the added amount of an alkali metal silicate may be proposed. This technique, however, may lead to silicon deficiency in a culture solution and thereby to a decrease in proliferation rate of diatoms. Moreover, in a case where diatoms consume the entire silicon in water, the diatoms may be killed due to the silicon deficiency in the water.

If it is possible to continuously add an appropriate amount of an alkali metal silicate in accordance with a degree to which the diatoms consume silicon, the added amount of the alkali metal silicate should not be excessive or insufficient. However, it is difficult to visually determine to what degree the diatoms have consumed silicon in water, and whether or not silicon still remains within the system.

In addition, an alkali metal silicate having a high alkaline property involves a disadvantage that control of concentration and pH is difficult and a problem of the safety in the handling when a high-concentration silicic acid solution is prepared.

Under these circumstances, it is in fact extremely difficult to continuously add an alkali metal silicate when mass culture of diatoms (for example, culture of 10 L (liter) or more) is desired, and therefore development of a new culture technology has been demanded.

The present invention has been made in order to solve the above-described problems. The object of the present invention is to provide a silicic acid component supplying agent for algae, which allows continuous supply of silicon to algae requiring silicon, such as diatoms, causes little precipitation even when added in excess, can be easily controlled so as not to cause silicon deficiency, and can be easily handled, and to provide a method of supplying a silicic acid component to algae.

### Means for Solving the Problems

Characteristic constitutions adopted in the present invention will now be described below.

A silicic acid component supplying agent for algae in the present invention is a silicic acid component supplying agent to be added to water in which algae requiring silicic acid to grow live, in order to supply a silicic acid component to the algae. The agent includes a silicic acid gel, as a main component, obtained by previously causing a reaction between an alkali metal silicate and a mineral acid within a system other than the water in which the algae live.

In the present invention, the silicic acid gel is obtained by a wet production method in which an alkali metal silicate solution and a mineral acid are reacted. Sodium silicate, potassium silicate, or the like may be used as the alkali metal silicate, and hydrochloric acid, sulfuric acid, nitric acid, or the like may be used as the mineral acid. It is industrially preferable to use sodium silicate and sulfuric acid.

In the present invention, it is preferable to use silicic acid hydrogel or silica xerogel as the silicic acid gel. Silicic acid hydrogel is in a state where silica colloid particles form a three-dimensional network structure by siloxane bond in the reaction process, and water is contained in the structure. Silica xerogel is in a state where silicic acid hydrogel is dried and the gel, which has shrunk due to drying, no longer shrinks. Silicic acid gel in either state may be used, and silicic acid gel in an intermediate state between the above both states may also be used. However, it is preferable to use silicic acid hydrogel in that silicic acid may be released more rapidly and at a higher concentration.

The silicic acid gel used in the present invention may have a granular, spherical, or any other configuration, and also may have suitable particle sizes depending on the type of usage. However, a smaller particle diameter is preferable in the case of requiring an immediate effect since the elution speed of silicic acid depends on the particle diameter of the silicic acid gel. Since an excessively small particle diameter tends to result in dust generation, a somewhat large particle diameter is preferable in terms of suppressing dust generation and facilitating easy handling.

The silicic acid component supplying agent for algae in the present invention, including a silicic acid gel as a main component, may also include a component necessary for proliferation of the algae in addition to the main component. Examples of such a component are various salts as supply sources of nitrogen, phosphorus, iron, etc.

The silicic acid component supplying agent for algae in the present invention may be added to water in any manner. It is, however, preferable that silicic acid gel in a particle state is filled in a container having gaps which inhibit passage of the silicic acid gel but allow passage of the silicic acid component eluted from the silicic acid gel, and is added to the water in which the algae live with the container so as to facilitate continuous control. The container having gaps which inhibit passage of the silicic acid gel but allow passage of the silicic acid component eluted from the silicic acid gel may be any container having liquid permeability, such as, for example, a container formed of a net or the like.

Alternatively, it may be possible to provide a second container filled with the silicic acid gel outside of a culture container of the algae, and pour a culture solution which has passed through the second container into the culture container.

When the silicic acid component supplying agent for algae is filled in such a container, it may be possible to stir the silicic acid gel in the container, and adjust the stirring amount such that the discharge amount of the silicic acid component to be eluted from the silicic acid gel and discharged to the outside of the container may be changed. Stirring may be performed in any manner, for example, by stirring with a rotating blade or stirring by aeration. Such stirring facilitates a further effective elution of the silicic acid.

When the silicic acid component supplying agent for algae as described above is added to the water in which the algae live, a silicic acid component may be supplied to the algae to facilitate proliferation of the algae.

Since the silicic acid component eluted from the silicic acid gel is dissolved very little by little in accordance with the silicic acid concentration in the water, the silicic acid concentration in the water is prevented from becoming excessively high. Accordingly, unlike the case of adding an alkali metal silicate to water, precipitation due to eluted silicic acid may be prevented.

More specifically, adding an alkali metal silicate to water involves a problem that the alkali metal silicate which has diffused in a system is gelled or produces a water-insoluble precipitate in an unexpected location in the system. In contrast, in the case of the silicic acid component supplying agent for algae in the present invention, the silicic acid gel as the main component is obtained by previously causing a reaction between an alkali metal silicate and a mineral acid within a system other than the water in which the algae live, and thus the silicic acid gel will not be gelled or produce a water-insoluble precipitate in an unexpected location in the system even when the silicic acid component eluted from the silicic acid gel diffuses in the system. Also, the silicic acid gel is dissolved up to 100% into the water without leaving residue in a long time period.

Accordingly, in the case of culturing algae in a culture tank, deposition or attachment of a precipitate on or to a drainage system or an aeration system provided in the culture tank may be avoided, and thus deterioration of the functions or failure of these systems due to the precipitate may be avoided.

Even when the silicic acid component supplying agent for algae in the present invention is added to water in excess, the silicic acid concentration in the water will not become excessively high. Accordingly, it is unnecessary to strictly control the added amount to the water. Thus, it may be possible to easily avoid reduction of the proliferation rate of the algae or death of the algae for lack of silicon in the water caused by excessively suppressing the added amount.

Also, in the case of the silicic acid component supplying agent for algae in the present invention, silicic acid gel in a solid state is added to water, unlike alkali metal silicate solution. Accordingly, it may be possible to visually observe the existence of the silicic acid gel after adding the silicic acid gel to the water. Thus, it may be possible to confirm whether or not the silicic acid gel still remains after adding the silicic acid gel to the water, and control, such as additionally adding the silicic acid component supplying agent for algae in the present invention when the remaining amount of the already added silicic acid gel becomes small, may be easily performed.

Furthermore, the silicic acid gel used in the silicic acid component supplying agent for algae in the present invention, which is neutral, is quite easy to handle and provides a high safety compared with alkali metal silicate having a strong alkaline property.

According to the silicic acid component supplying agent for algae in the present invention, as described above, it may be possible to supply silicon to algae, cause little precipitation even when the agent is added in excess, easily control the agent so as not to cause silicon deficiency, and easily handle the agent.

While the above-described silicic acid component supplying agent for algae includes silicic acid gel as a main component, silicic acid sol may be used instead of the silicic acid gel. Specifically, the silicic acid component supplying agent for algae in the present invention may include a silicic acid sol, as a main component, obtained by previously causing a reaction between an alkali metal silicate and a mineral acid within a system other than the water in which the algae requiring silicic acid to grow live.

According to the silicic acid component supplying agent for algae in this case, it may also be possible to supply silicon to algae, cause little precipitation even when the agent is added in excess, and easily handle the agent. However, in the case of including silicic acid sol as a main component, the silicic acid component supplying agent for algae easily diffuses into the system, compared with the case of including silicic acid gel as a main component. Accordingly, the silicic acid component supplying agent for algae including silicic acid gel as a main component may be more advantageous in order to maintain and control the silicon concentration by visual observation.

### BRIEF DESCRIPTION OF THE DRAWINGS

FIGS. 1A-1B are a graph showing changes in proliferation rate of Chaetoceros in a culture solution, and a graph showing changes in Si concentration in the culture solution; and

FIG. 2 is a graph showing changes in cell volume of Navicula in the culture solution.

### BEST MODE FOR CARRYING OUT THE INVENTION

An embodiment of the present invention will now be described by way of a specific example.

### Embodiment 1

A silicic acid hydrogel was prepared using an alkali metal silicate solution and a mineral acid by a known method (for example, a method described in Unexamined Japanese Patent Publication No. 62-207712 or in Unexamined Japanese Patent Publication No. 64-33012). Specifically, sodium silicate (SiO₂ 17 wt %) and 1.95 mol/l of sulfuric acid were continuously mixed, and the mixture was gelled in the air and was received by a tank filled with water. After sufficient washing, spherical silicic acid hydrogel having particle diameters of 2-10 mm was obtained.

Measurement of the weight decrease by a drier at 180° C. showed that the water content of the obtained silicic acid hydrogel was 80%. Also, when 5 g of the silicic acid hydrogel was added to 100 mL of iron-exchanged water and was stirred for 10 minutes, the pH of the water became 6.2.

30 g of the silicic acid hydrogel was added to a 1 L beaker, and 400 mL of natural sea water was added and stirred with a stirrer for 1 hour at an ambient temperature.

The supernatant sea water was obtained, and the silicon concentration was measured by ICP emission spectrometry. The silicon concentration of the raw natural sea water was 0.7 ppm and the silicon concentration of the sea water after adding the silicic acid hydrogel was 63 ppm.

### Embodiment 2

50 g of the silicic acid hydrogel prepared in Embodiment 1 was added to 1000 mL of natural sea water and the sea water was left at rest for 7 days while being occasionally stirred. For comparison purpose, 1000 mL of natural sea water with 50 g of soda-glass cullet therein and 1000 mL of raw natural sea water without any added substance were left at rest for 7 days in a same manner.

The supernatant sea water was obtained, and the silicon concentration was measured by ICP emission spectrometry. The silicon concentrations of the raw natural sea water, the natural sea water after adding the silicic acid hydrogel, and the sea water after adding the soda-glass cullet, after being left at rest, were 0.7 ppm, 100 ppm, and 34 ppm, respectively.

### Embodiment 3

The silicic acid hydrogel prepared in Embodiment 1 was added to a culture solution, and Chaetoceros, which is a centric diatom species, was cultured therein (hereinafter referred to as the “experimental plot”).

The employed culture method was the batch-culture method with a culture size of 10 L. A nylon mesh bag (an example of “a container having gaps which inhibit passage of silicic acid gel but allow passage of a silicic acid component eluted from the silicic acid gel” in the present invention) was attached to an air vent, and approximately 10 g of the silicic acid hydrogel was contained in the mesh bag. According to this method, the silicic acid hydrogel is oscillated by aeration so as to cause Si to be easily dissolved into the culture solution.

The composition of the culture solution was NaNO₃: 600 mg, NaH₂PO₄.4H₂O: 40 mg, Fe-EDTA 38.4 mg, MnCL₂4H₂O: 1.44 mg, CuSO₄.5H₂O: 80 μg, ZnSO₄.7H₂O: 184 μg, CoCl₂.6H₂O: 80 μg, Na₂MoO₄2H₂O: 50.4 μg, vitamin B₁₂: 4 μg, biotin: 4 μg, thiamine HCl: 800 μg for 1 L of sea water. The silicic acid hydrogel was added to the culture solution.

The Chaetoceros density after inoculation was approximately 500,000/mL. Culturing was performed under the conditions of batch-type continuous aeration, a temperature of 25° C., and continuous lighting at an illuminance of approximately 50001× with a fluorescent lamp.

For comparison purpose, Chaetoceros was cultured using a culture solution prepared to contain four times the contents of nutrients which are contained in Guillard F medium (containing sodium metasilicate as a silicic acid source) (hereinafter referred to as the “control plot”).

The composition of the culture solution containing four times the contents of nutrients which are contained in Guillard F medium was NaNO₃: 600 mg, NaH₂PO₄4H₂O: 40 mg, Fe-EDTA 38.4 mg, Na₂SiO₂.9H₂O: 120 mg, MnCL₂.4H₂O: 1.44 mg, CuSO₄.5H₂O: 80 μg, ZnSO₄.7H₂O: 184 μg, CoCl₂.6H₂O: 80 μg, Na₂MoO₄.2H₂O: 50.4 μg, vitamin B₁₂: 4 μg, biotin: 4 μg, thiamine HCl: 800 μg for 1 L of sea water.

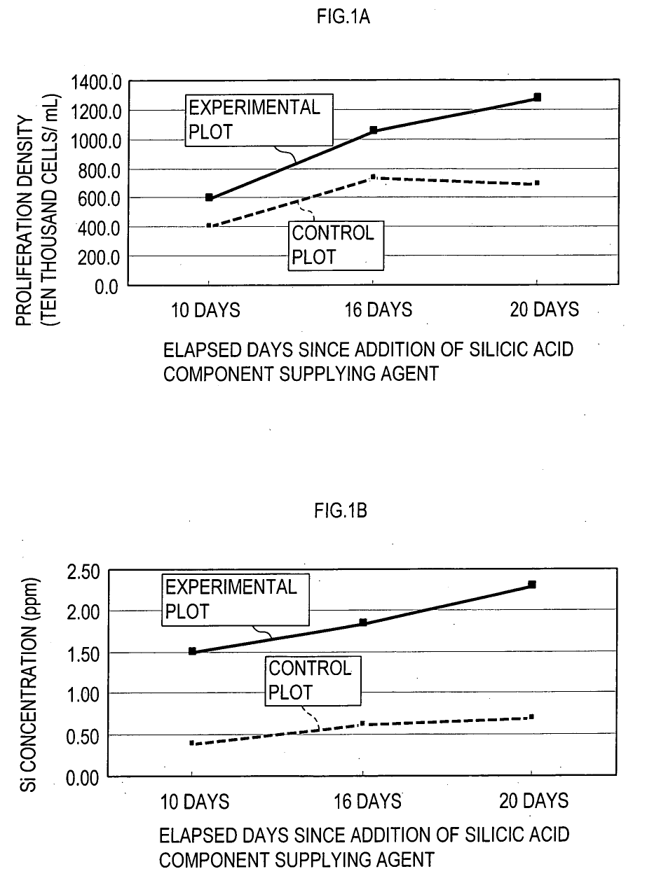

Proliferation densities on the 10th, 16th and 20th days were measured with a Neubauer hematocytometer both in the experimental plot and in the control plot. The measurement results are shown in FIG. 1A.

Also, Si concentrations on the 10th, 16th and 20th days were measured by a calorimetric method (Heteropoly Blue Method) both in the experimental plot and in the control plot. The measurement results are shown in FIG. 1B.

These results show that the Si concentration may remain high and proliferation of Chaetoceros may be performed steadily in the case where the silicic acid hydrogel is added to the culture solution compared with the case where sodium metasilicate is added as in the control plot.

### Embodiment 4

With respect to Chaetoceros cultured for 20 days after the silicic acid hydrogel and sodium metasilicate were added in an experimental plot and a control plot, respectively, under the same conditions as in Embodiment 3, difference in pigment and chlorophyll a content were examined.

20 mL of culture solution was collected from each of the experimental plot and the control plot, each cell density was measured, and only the cells were collected by suction filtration with a GF/F filter having a diameter of 47 mm (Whatman International Ltd.).

Chlorophyll a was measured by a fluorescence method with a fluorometer (Turner Designs, Inc.) or by a measurement method with a spectrophotometer (Shimadzu Corporation).

Visual observation of glass bottles with the culture solutions after culturing for 20 days showed that the experimental plot had an obviously deeper color, indicating presence of Chaetoceros with a high density, than the control plot.

Visual observation of Chaetoceros collected on the filters showed that the experimental plot presented a deep brown color, while the control plot presented a light brown color. This appears to be caused due to the difference in the growth of chloroplast in the cells.

The chlorophyll a content in the experimental plot was 0.22-0.24 (pg/cell), while the content in the chlorophyll a content in the control plot was 0.12-0.16 (pg/cell).

It is usually considered that a cell with grown chloroplasts has a high protein and fat content, and is nutritious. Accordingly, use of the silicic acid hydrogel may be considered to contribute to production of diatoms rich in nutrients.

### Embodiment 5

Instead of the silicic acid hydrogel used in Embodiments 1-4, silica xerogel (JIS A-type, particle diameter: approximately 1.7 mm-4.0 mm) contained in a nylon mesh bag was put into a large raceway-type outdoor culture tank, and diatoms were cultured in the tank. The diatoms proliferated steadily.

The same silica xerogel as above was put into a transparent polycarbonate culture tank, and diatoms were cultured in the tank. The diatoms proliferated steadily.

The same silica xerogel as above was attached to a corrugated panel for proliferation of epilithic diatoms, and diatoms were cultured. The diatoms proliferated steadily.

### Embodiment 6

Silica sol was put into a large raceway-type outdoor culture tank instead of the silicic acid hydrogel used in Embodiments 1-4, and diatoms were cultured in the tank. The diatoms proliferated steadily.

### Embodiment 7

Mono-species culture of an epilithic diatom, Navicula (Navicula ramossima), which is useful as a food for epilithic larvae of sea urchins and sea cucumbers, was performed. Culturing was performed in the form of batch-type aeration culture with a culture size of 500 mL. The same culture solutions as in the experimental plot and the control plot, respectively, in Embodiment 3 were used. However, in the experimental plot, 10 g of the silicic acid hydrogel prepared in Embodiment 1 was added to 500 mL of the culture solution.

Mono-species culture of Navicula was performed without placing any attachment substrate, such as a plastic plate, in a culture container, in order to facilitate comparison of only the properties of the silicic acid hydrogel prepared in Embodiment 1 with those of sodium metasilicate. Culturing was performed under the conditions of 12 days, 25° C. and continuous lighting.

It is extremely difficult to obtain an accurate yield of the epilithic diatom. Accordingly, the yield of the epilithic diatom was calculated according to the following method in Embodiment 7. Specifically, hard stirring was performed in the culture container once every three days from the 3rd day to the 12th day to cause cells attached to the culture container to float, a specified amount of the culture solution including the floating cells was collected, and a collected cell volume (a cell volume per 1 mL culture solution) was measured with a capillary centrifuging tube.

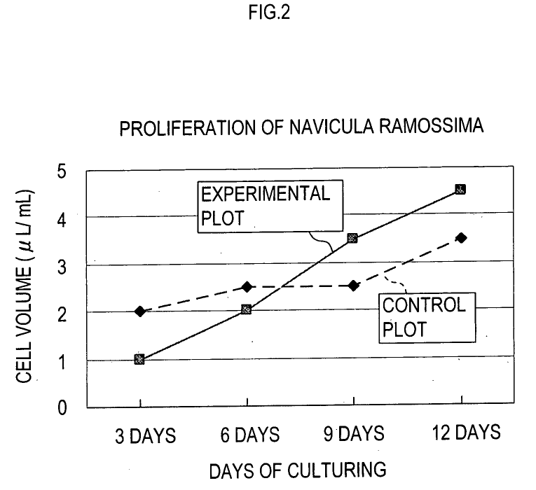

FIG. 2 shows changes in the collected cell volume. As clearly shown in FIG. 2, Navicula grew quite steadily in the experimental plot. Specifically, the cell volume in the experimental plot, which was smaller than the cell volume in the control plot on the 3rd day, became larger than that in the control plot on the 9th day, and Navicula also proliferated steadily thereafter.

Microscopic observation of a group of cells of Navicula which have proliferated in each of the experimental plot and the control plot showed no particular difference between the both plots.

In view of the above results, Navicula is considered to grow equally in the case of adding the silicic acid hydrogel prepared in Embodiment 1 as a silicic acid source, as compared with the case of adding sodium metasilicate.

### MODIFIED EXAMPLES, AND THE LIKE

Although embodiments of the present invention have been described, the present invention should not be limited to any particular one of the above embodiments, but may be embodied in other various forms.

For example, although examples of culturing Chaetoceros and Navicula, each of which is a type of diatom, are shown in the above embodiments, the silicic acid component supplying agent for algae in the present invention may be used for other floating diatoms, epilithic diatoms, or algae (for example, Synura) which take silicic acid as a nutrient salt.

While culture tanks of specific types or configurations are exemplarily indicated in the above embodiments, types or configurations of the culture tank are optional. For example, the culture tank may be outdoor type or indoor type, and may be relatively small or large.

Furthermore, the above embodiments include a case where the silicic acid hydrogel is oscillated by aeration so as to cause Si to be easily dissolved in the culture solution. However, it may also be possible to cause Si to be easily dissolved in the culture solution by rotating a stirring blade to stir silicic acid gel. When a sufficient amount of Si is to be dissolved into the culture solution without oscillating silicic acid gel, for example, in a case where a sufficient amount of silicic acid gel is added to the system, it is unnecessary to oscillate the silicic acid gel.

1. A silicic acid component supplying agent for algae to be added to water in which algae requiring silicic acid to grow live, in order to supply a silicic acid component to the algae, the agent comprising:
a silicic acid gel, as a main component, obtained by previously causing a reaction between an alkali metal silicate and a mineral acid within a system other than the water in which the algae live.

2. The silicic acid component supplying agent for algae according to claim 1, wherein the silicic acid gel is silicic acid hydrogel.

3. The silicic acid component supplying agent for algae according to claim 1, wherein the silicic acid gel is silica xerogel.

4. A silicic acid component supplying agent for algae to be added to water in which algae requiring silicic acid to grow live, in order to supply a silicic acid component to the algae, the agent comprising:
a silicic acid sol, as a main component, obtained by previously causing a reaction between an alkali metal silicate and a mineral acid within a system other than the water in which the algae live.

5. A method of supplying a silicic acid component to algae requiring silicic acid to grow, comprising the step of:
adding a silicic acid component supplying agent for algae to water in which the algae live, the agent including a silicic acid gel, as a main component, obtained by previously causing a reaction between an alkali metal silicate and a mineral acid within a system other than the water in which the algae live.

6. The method of supplying a silicic acid component to algae according to claim 5, wherein the silicic acid gel in a particle state is filled in a container having gaps which inhibit passage of the silicic acid gel but allow passage of the silicic acid component eluted from the silicic acid gel, and is added to the water in which the algae live with the container.

7. A method of supplying a silicic acid component to algae requiring silicic acid to grow, comprising the step of:
adding a silicic acid component supplying agent for algae to water in which the algae live, the agent including a silicic acid sol, as a main component, obtained by previously causing a reaction between an alkali metal silicate and a mineral acid within a system other than the water in which the algae live.
